(19) United States
(12) Patent Application Publication
(10) Pub. No.: US 2025/0071350 A1
(43) Pub. Date: Feb. 27, 2025

(54) TRANSMITTING VIDEO SUB-STREAMS CAPTURED FROM SOURCE SUB-LOCATIONS TO EXTENDED-REALITY HEADSETS WORN BY VIEWERS AT A TARGET LOCATION

(71) Applicant: INTERNATIONAL BUSINESS MACHINES CORPORATION, Armonk, NY (US)

(72) Inventor: Charan Acharya Chandrashekar, Bangalore (IN)

(21) Appl. No.: 18/452,964

(22) Filed: Aug. 21, 2023

(51) Int. Cl. H04N 21/231; G02B 27/01; H04N 21/218

(52) U.S. Cl. CPC H04N 21/23116; G02B 27/0172; H04N 21/21805; H04N 21/23106

(57) ABSTRACT

Provided are a computer program product, system, and method for transmitting video sub-streams captured from source sub-locations to extended-reality headsets worn by viewers at a target location. Video cameras, positioned to capture video at a source location, are assigned to source sub-locations of the source location. The video cameras assigned to a source sub-location capture video of the event from points-of-view of viewers within the source sub-location. The source sub-locations of the source location are associated with target sub-locations of a target location in which the viewer is located. The source location and the target location are in different geographical locations. A video sub-stream from video cameras assigned to a source sub-location is transmitted to be rendered in the extended-reality headset worn by a viewer located in a target sub-location associated with the source sub-location to which the video cameras that captured the video sub-stream are assigned.

### BACKGROUND OF THE INVENTION

### 1. Field of the Invention

The present invention relates to a computer program product, system, and method for transmitting video sub-streams captured from source sub-locations to extended-reality headsets worn by viewers at a target location.

### 2. Description of the Related Art

A video Content Delivery Network (CDN) is a network of servers that are distributed globally and designed to deliver video content to users. A video CDN works by caching and replicating video content to multiple servers in different geographic locations, so that users can access the content from a server that is closer to their location, thereby reducing the latency and improving the video streaming experience.

Cloud systems may be used to stream volumetric video that captures video representing a three-dimensional space that users can view from many angles. Volumetric video software captures a scene from multiple video cameras operating in unison. The captured video from the cameras is processed by reconstruction software to create high-quality photorealistic three-dimensional video that may be used in live broadcasts transmitted to extended-reality headsets, such as virtual reality or augmented reality goggles.

### SUMMARY

Provided are a computer program product, system, and method for transmitting video sub-streams captured from source sub-locations to extended-reality headsets worn by viewers at a target location. Video cameras, positioned to capture video at a source location, are assigned to source sub-locations of the source location. The video cameras assigned to a source sub-location capture video of the event from points-of-view of viewers within the source sub-location. The source sub-locations of the source location are associated with target sub-locations of a target location in which the viewer is located. The source location and the target location are in different geographical locations. A video sub-stream from video cameras assigned to a source sub-location is transmitted to be rendered in the extended-reality headset worn by a viewer located in a target sub-location associated with the source sub-location to which the video cameras that captured the video sub-stream are assigned.

### BRIEF DESCRIPTION OF THE DRAWINGS

FIG. 1 illustrates an embodiment of a video streaming environment in which video is captured from a source location and transmitted to viewers at a target location wearing extended-reality headsets.

FIG. 2 illustrates an embodiment of a video camera for capturing a video sub-stream at the source location.

FIG. 3 illustrates an embodiment of an extended-reality headset to render a video sub-stream captured from a source sub-location of source location.

FIG. 4 illustrates an embodiment of a target content delivery server to transmit video sub-streams taken from source sub-locations to viewers at corresponding target sub-locations of a target location to view on their extended-reality headset.

FIG. 5 illustrates an embodiment of a source sub-location video assignments for video cameras at the source location.

FIG. 6 illustrates an embodiment of target sub-location video assignments used by target content delivery servers to transmit video sub-streams for the source sub-locations to viewers.

FIG. 7 illustrates an embodiment of operations performed by main content delivery server to configure target content delivery servers to transmit video sub-streams from source sub-locations to viewers at corresponding target sub-locations at a target location.

FIG. 8 illustrates an embodiment of operations for a target content delivery server to process a request from a viewer extended-reality headset for a video sub-stream of content captured from a source sub-location.

FIG. 9 illustrates an embodiment of operations performed by an extended-reality headset to select a broadcasted video sub-stream to render at the extended-reality headset.

FIG. 10 illustrates a computing environment in which the components of FIGS. 1 and 2 may be implemented.

### DETAILED DESCRIPTION

Streaming volumetric video in real-time requires significant bandwidth and can be challenging in situations where network speeds are limited or inconsistent. Described embodiments provide improvements to computer technology for delivering video content, such as volumetric video, to viewers wearing extended-reality headsets to watch the content virtually. Described embodiments assign source sub-locations at a source location of an event that is to be captured and broadcasted to target sub-locations at a target location where there are viewers wearing extended-reality headsets to virtually view the event at the target location.

To minimize use of network bandwidth and improve network latency, described embodiments transmit video sub-streams of video captures from source sub-locations comprising only a portion of the video captured at the source location from all the video cameras at the source location. The video sub-streams capture video from the points-of-view or perspective of people located in a particular source sub-location of the source location. The video sub-streams for a source sub-location, comprising only a portion of the video for a source location, are transmitted to target content delivery servers, such as edge servers, which transmit only the video sub-stream for the source sub-location to which they are assigned. In this way, only portions of video sub-streams are transferred to the target content delivery server instead of having to transmit the entire video stream to the edge servers in order to conserve network bandwidth and reduce network latency.

Further, in described embodiments, the target content delivery servers, which are closest to target sub-locations, transmit video to viewers in the target sub-location that is closest to the target content delivery server to increase transfer speed over the shortest possible distance.

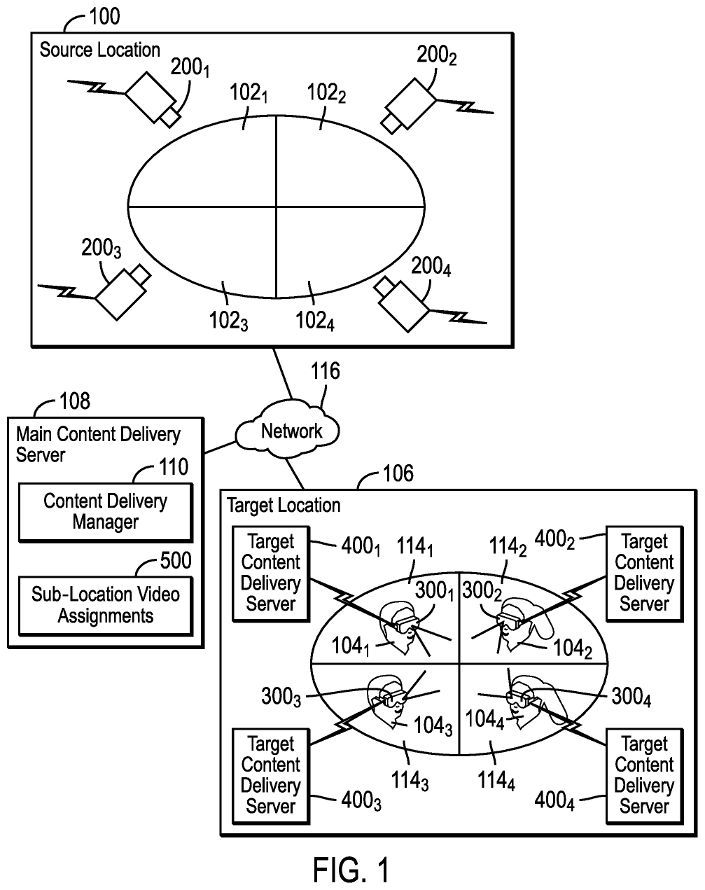

FIG. 1 illustrates an embodiment of a virtual event broadcasting environment having a source location 100 including a plurality of volumetric cameras 200₁ 200₂, 200₃, 200₄. Each of the volumetric cameras 200ᵢ record video from a perspective or point-of-view of people situated in source sub-locations 102₁, 102₂, 102₃, 102₄, which may comprise non-overlapping sections of the source location 100 Each of the instances of volumetric cameras 200ᵢ may represent a plurality of volumetric video cameras to capture video from different points-of-view of people located within a source sub-location 102ᵢ. There may be more or fewer source sub-locations than shown and corresponding sets of volumetric video cameras filming within the source sub-locations. The source location 100 may comprise a venue where a large event is being held, such as a stadium where the attendees and the video cameras 200₁ 200₂, 200₃, 200₄ are viewing a central part of the source location 100, such as a stadium or stage in the center or other area of the source location 100. The event being captured at the source location 100 may comprise a concert, sporting event, political rally, social gathering, etc. The video cameras 200₁ 200₂, 200₃, 200₄ capture video of the event from the perspective of the points-of view of people in the different source sub-locations 102₁, 102₂, 102₃, 102₄ to broadcast to viewers 104₁, 104₂, 104₃, 104₄ wearing extended-reality headsets 300₁, 300₂, 300₃, 300₄ to watch the content virtually at another target location 106. The viewers 104; may be unable to attend the event at the source location 100, but still want to view at another target location 106 to view virtually. Each shown viewer 104; may represent a plurality of viewers.

A main content delivery server 108 includes a content delivery manager 110 to manage the distribution of video sub-streams, captured by the video cameras 200₁ 200₂, 200₃, 200₄, to target content delivery servers 400₁, 400₂. 400₃, 400₄, such as edge servers The content delivery manager 110 maintains source sub-location video assignments 500 that associate source sub-locations 102₁, 102₂, 102₃, 102₄ with corresponding target sub locations 114₁, 114₂, 114₃, 114₄, respectively, and associate the video cameras 200₁ 200₂, 200₃, 200₄ with the source sub-locations 102₁, 102₂, 102₃, 102₄ in which the video cameras 200₁ 200₂, 200₃, 200₄ are capturing content. The source sub-location video assignments 500 indicate the target content delivery servers 400₁, 400₂, 400₃, 400₄ that cache video sub-streams for the video cameras 200₁ 200₂, 200₃, 200₄, such that a target content delivery server 400ᵢ assigned to a particular target sub-location 114ᵢ caches captured video sub-streams from video cameras 200ᵢ assigned to the source sub-location 102ᵢ that maps/corresponds to the target sub-location 114ᵢ assigned to the target content delivery server 400ᵢ.

In one embodiment, the target sub-locations and the source sub-locations comprise non-overlapping areas of the target location and source location, respectively.

In one embodiment, the video cameras 200ᵢ capturing video for points-of view at source sub-location 102ᵢ may transmit their video sub-streams to the main content delivery server 108 to reconstruct the video sub-streams for a source sub-location into a single volumetric video sub-stream, for the source sub-location, that is then distributed to the target content delivery server 112ᵢ corresponding to the source sub-location 102ᵢ assigned the video cameras 200ᵢ that produced the video sub-stream. In alternative embodiments, the content delivery manager 110 may program the video cameras 200₁ 200₂, 200₃, 200₄ to transmit their video directly to the associated target content delivery server 400ᵢ.

Each of the target sub-locations 114₁, 114₂, 114₃, 114₄ may include viewers 104₁, 104₂, 104₃, 104₄ that are positioned in the target sub-locations 114₁, 114₂, 114₃, 114₄ and wear extended-reality headsets 300₁, 300₂, 300₃, 300₄, respectively, to render a virtual representation of the event at the source location 100 at the target location 106 for the viewers to watch. In certain embodiments, the viewers 104₁, 104₂, 104₃, 104₄ are gazing toward a center of the target location 106 in a same orientation, e.g., point-of-view, as attendees of the distributed event at the source location 100.

In the exemplar embodiment of FIG. 1, there are shown four instances of the source sub-locations 102ᵢ, target sub-locations 114ᵢ, video cameras 200ᵢ, and target content delivery servers 400ᵢ. In actual implementations there may be any number of these elements 102ᵢ, 104ᵢ, 114ᵢ, 200ᵢ, and 400ᵢ at the source location 100 and target location 106. Further, the main content delivery system 108 may manage transmissions from one or more source locations to multiple target locations.

In certain embodiments, the target location 106 comprises a venue at which viewers 104₁, 104₂, 140₃, 104₄ can view the event being recorded at the source location 100 through the extended-reality headset 300ᵢ. In an alternative embodiment, the target location 106 may comprise a room, where one or more people may gather to receive video sub-streams from adjacent target content delivery servers 400₁, 400₂, 400₃, 400₄ closest to the target sub-locations 114₁, 114₂, 114₃, 114₄ which include the one or more viewers.

In certain embodiments, the video cameras 200ᵢ may comprise volumetric video cameras to capture volumetric video. Although embodiments are described with respect to volumetric video, in alternative embodiments, other types of video, images and/or audio of the source location 100 may be captured by the video cameras.

The video sub-streams captured by video cameras 200ᵢ in a source sub-location 102ᵢ may be combined to form a single volumetric video sub-stream from the perspective, i.e., points-of-view, of people viewing from within the source sub-location 102ᵢ.

In one embodiment, the extended-reality headset 300ᵢ may comprise a type of computer vision headset to render extended-reality virtual objects. The extended-reality headset 300ᵢ may further comprise a gaze tracking device to receive a gazed virtual object detected by eye tracking cameras that acquire the gazed virtual object on which the tracked eye is fixed and information on coordinates of an axis of a line-of-sight, also referred to as sightline, visual axis, the user is viewing within the field of vision captured by the gaze tracking device tracking. Extended-reality smart headset are wearable computer-capable headset that generate virtual objects, such as three-dimensional images, text, animations, and videos, to overlay into the wearer's field of vision so the digital information is viewable along with real-world scenes in the wearer's field of vision. The display 300ᵢ may further provide augmented reality (AR) virtual objects. Augmented reality is used to supplement information presented to users on items they are looking at. such as augmented reality controls to control items in the wearer's field of vision or information on locations in the field of vision. Additionally, the extended-reality headset 300ᵢ may provide extended-reality virtual objects that interact with the real-world. For instance, a person wearing an extended-reality headset may interact with an extended-reality virtual object and react with that virtual object in the same way the viewer would interact with the object in the real-world, such as move closer to the user as the user moves closer to the virtual object.

The extended-reality headset 300ᵢ include a processor, display, sensors and input devices, and may include many of the components found in smartphones and tablet computers. Extended-reality rendering may be performed by optical projection systems, monitors, handheld devices, and display systems worn on the human body. A head-mounted display (HMD) is a display device worn on the forehead, such as a harness or helmet-mounted. HMDs place images of both the physical world and virtual objects over the user's field of view. Modern HMDs often employ sensors for six degrees of freedom monitoring that allow the system to align virtual information to the physical world and adjust accordingly with the user's head movements. The HMDs may also implement gesture controls for full virtual immersion.

Extended-reality reality headsets 300ᵢ may comprise displays rendered on devices resembling eyeglasses, and employ cameras to intercept real-world view and re-display its augmented view through the eye pieces and devices in which MR imagery is projected through or reflected off the surfaces of the eyewear lens places. Other implementations of MR displays include a head-up display (HUD), which is a transparent display that presents data without requiring users to look away from their usual viewpoints. Extended-reality may include overlaying the information and registration and tracking between the superimposed perceptions, sensations, information, data, and images and some portion of the real-world. Additional extended-reality implementations include contact lenses and virtual retinal display, where a display is scanned directly into the retina of a viewer's eye. EyeTap augmented reality devices capture rays of light that would otherwise pass through the center of the lens of the wearer's eye, and substitutes synthetic computer-controlled light for each ray of real light. The extended-reality headset 300ᵢ may further use motion tracking technologies, including digital cameras and/or other optical sensors, accelerometers, GPS, gyroscopes, solid state compasses, radio-frequency identification (RFID).

Extended-reality, as that term is used herein, refers to any of virtual reality (VR), where the entire view of the user is synthetic imagery, augmented reality (AR) where virtual objects or synthetic imagery are added to a view of a real environment, mixed reality (MR) where there is a combination of synthetic and real imagery to form the space, and augmented virtuality (AV) where real imagery is added to a synthetic environment. Thus, extended-reality, as that term is used herein, falls on the continuum from total virtuality or total synthetic imagery to a combination of synthetic and real imagery.

In a virtual reality environment, the extended-reality headset 300ᵢ renders the entire environment so the participant is fully immersed in the broadcasting of the event. In an augmented reality environment, elements of the event occurring at the source location 100 are rendered within the viewers 104ᵢ extended-reality headset 300ᵢ as superimposed on the real-world environment at the target location 106.

The video cameras 200ᵢ, or systems at the source location 100, the main content delivery server 108, and the target content delivery servers 400ᵢ may communicate over a network 116. The network 116 may comprise a network such as a Storage Area Network (SAN), Local Area Network (LAN), Intranet, the Internet, Wide Area Network (WAN), peer-to-peer network, wireless network, arbitrated loop network, etc.

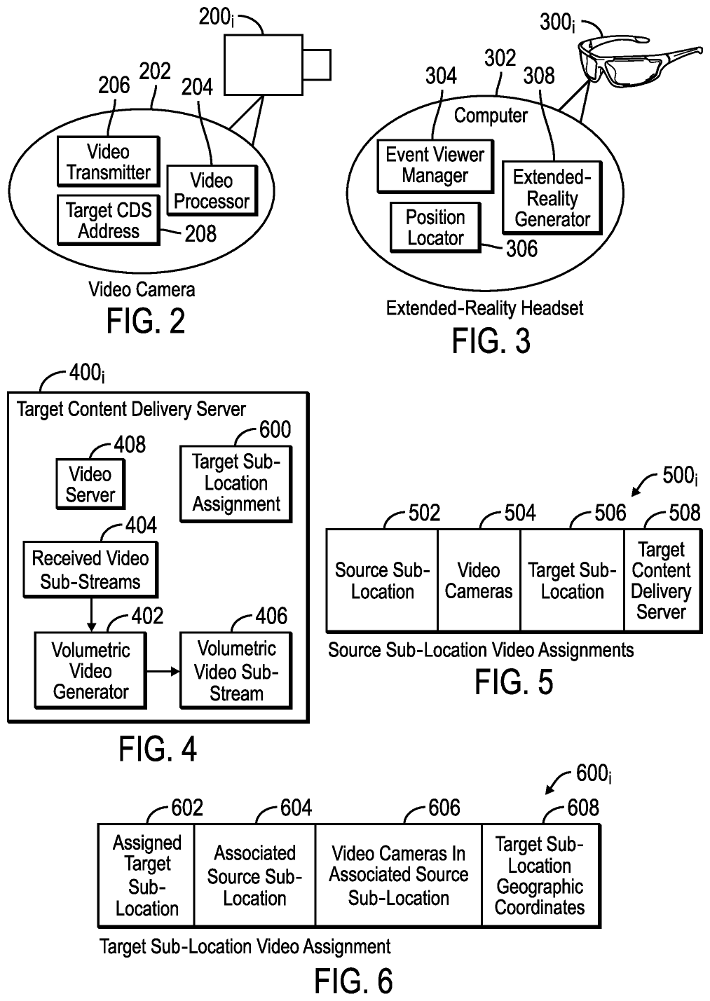

FIG. 2 illustrates an embodiment of a video camera 200ᵢ, such as one of video cameras 200₁ 200₂, 200₃, 200₄, that includes a computational unit 202 including: a video processor 204 to process video captured by the camera 200ᵢ, such as volumetric video; a video transmitter 206 to transmit video to the main content delivery server 108 or a target content delivery server (CDS) address 208 of a target content delivery server 400ᵢ to directly receive the video sub-stream from the cameras 200ᵢ. The video from all the cameras 200ᵢ at the source location 100 may be synchronized to synchronize their video capture and transmission. Alternatively, the video cameras 200ᵢ may transmit their video sub-streams to the main content delivery server 108, which reconstructs the volumetric video stream form the video sub-streams, to then distribute the reconstructed volumetric sub-stream to the target content delivery servers 400ᵢ.

FIG. 3 illustrates an embodiment of an extended-reality headset 300ᵢ as including a computer system 302 that includes an event viewer manager 304 to process transmitted video sub-streams of an event; a position locator 306 to determine geographic coordinates of the viewer wearing the extended-reality headset 300ᵢ; and an extended-reality generator 308 to render the event in the extended-reality headset 300ᵢ.

FIG. 4 illustrates an embodiment of the components at the target content delivery server 400ᵢ as including a target sub-location assignment 600 indicating a target sub-location 114ᵢ to which the video is transmitted; a volumetric video generator 402 to receive video sub-streams 404 generated by the video cameras 200ᵢ and reconstruct the received video streams sub-streams 404 into a volumetric video sub-stream 406 that a video server 408 may transmit to the extended-reality headsets 300ᵢ at the target location 106ᵢ and target sub-location assignment 600 indicating a target sub-location to which the target content delivery server 400ᵢ is assigned to transmit the volumetric video sub-stream 406 for that target sub-location 602.

The arrows shown in FIG. 4 between the components and objects in the target content delivery server 400 represent a data flow between the components.

Generally, program modules, such as the program components 110, 204, 206, 304, 308, 402, 408, among others, of systems 108, 200ᵢ, 300ᵢ, 400ᵢ, may comprise routines, programs, objects, components, logic, data structures, and so on that perform particular tasks or implement particular abstract data types. The program components and hardware devices of the systems 108, 200ᵢ, 300ᵢ, 400ᵢ of FIGS. 1 and 2 may be implemented in one or more computer systems, where if they are implemented in multiple computer systems, then the computer systems may communicate over a network.

The program components 110, 204, 206, 304, 306, 308, 402, 408 components of systems 108, 200ᵢ, 300ᵢ, 400ᵢ may be accessed by a processor from memory to execute. Alternatively, some or all of the program components 110, 204, 206, 304, 306, 308, 402, 408, program components of system 108, 200ᵢ, 300ᵢ, 400ᵢ may be implemented in separate hardware devices, such as Application Specific Integrated Circuit (ASIC) hardware devices and Field Programmable Gate Array (FPGA).

The functions described as performed by the program components 110, 204, 206, 304, 306, 308, 402, 408 may be implemented as program code in fewer program modules than shown or implemented as program code throughout a greater number of program modules than shown.

The content delivery servers 108 and 400ᵢ may comprise enterprise computing systems and the target content delivery servers 400ᵢ may comprise edge servers closest to the target sub-locations to which they will transmit video sub-streams.

FIG. 5 illustrates an embodiment of an instance of source sub-location video assignments 500ᵢ for a source location 100, comprising: a source sub-location 502 identifying a source sub-location 102ᵢ at a source location 100; video cameras 504 positioned to capture video from points-of-view of people in the source sub-location 502; a target sub-location 506 assigned or mapping to the source sub-location 502, such that the video stream from source sub-location 502 is transmitted to the target sub-location 506; and a target content delivery server 508 assigned to cache the video sub-stream for the source sub-location 502 to transmit to the target sub-location 506.

In described embodiments the video cameras 504 may be positioned on an outer boundary of the source sub-location 502 or around the stage, court, field or locus of attention where the event is taking place to capture video from points-of-view of attendees in the source sub-location 502 looking toward a center of the source location 100, such as toward a center athletic field/court, stage, boxing ring, locus of attention, such as a golf course hole, mountain ski run, etc. In further embodiments, the video cameras 504 may include video cameras positioned within the source sub-location 502 pointing in different directions to capture videos from different points-of-view of people in the source sub-location 502 looking in different directions from within the source sub-location 502.

In certain embodiments, people located in a source sub-location 502 may have the same points-of-view of people located in a corresponding target sub-location 506 even though the relative sizes of the locations 502 and 506 may differ.

There may be multiple instances of source sub-location video assignments 500 for different source locations, such as different venues.

FIG. 6 illustrates an embodiment of an instance of target sub-location video assignment 600ᵢ maintained for a target content delivery server 400ᵢ at a target location 106 including: an assigned target sub-location 602 identifying a target sub-location 114ᵢ at the target location 106 to which the target content delivery server 400ᵢ streams a video sub-stream; an associated source sub-location 604 comprising the source sub-location 102ᵢ that maps to the target sub-location 602 in source sub-location vide assignments 500ᵢ; video cameras in the associated source sub-location 606 that capture video from points-of-view within the associated source sub-location 604; and target sub-location geographic coordinates 608 of the target sub-location 602.

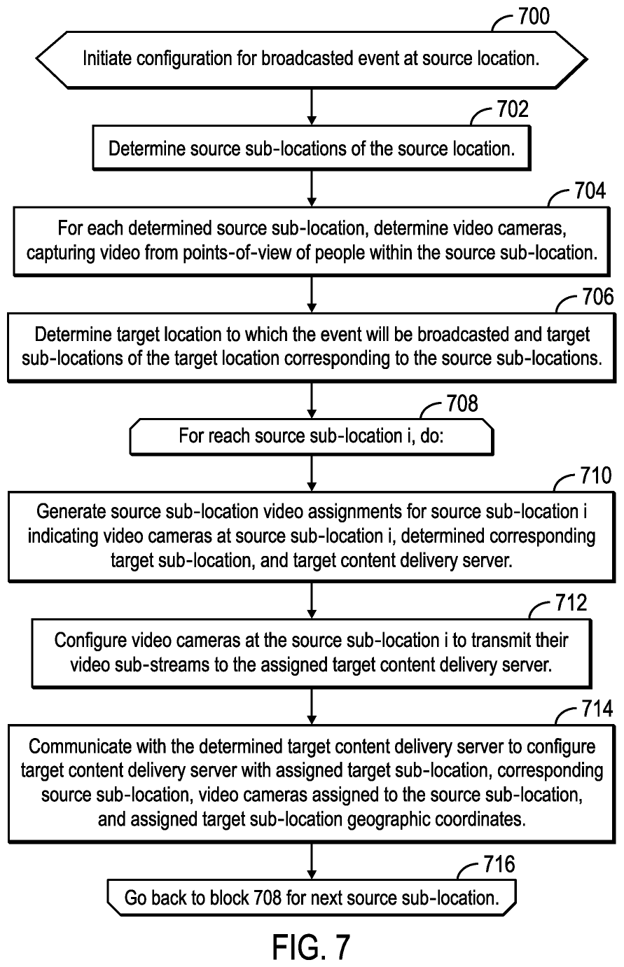

FIG. 7 illustrates an embodiment of operations performed by the content delivery manager 110 in the main content delivery server 108 to configure the target content delivery servers 400ᵢ to transmit video from an event at a source location 100. Upon initiating (at block 700) configuration of target content delivery servers 400ᵢ for a broadcasted event at the source location 100, the main content delivery server 108 determines (at block 702) source sub-locations 102₁ . . . 102₄ at the source location 100. The content delivery manager 110 determines (at block 704), for each determined source sub-location 102ᵢ, video cameras 200ᵢ, capturing video from points-of-view of people within the source sub-location 102ᵢ. The content delivery manager 110 further determines (at block 706) a target location 106 to which the event will be broadcasted and target sub-locations 114ᵢ of the target location 106 corresponding to the source sub-locations 102ᵢ, such as a target sub-location 114ᵢ in which people will have the same points-of-view as people in the corresponding source sub-location 102ᵢ. In this way, the determination at block 706 provides a mapping/correspondence/association of source sub-locations 102ᵢ and target sub-location 114ᵢ.

For each source sub-location 102ᵢ, the content delivery manager 110 performs the operations at blocks 708 through 716. At block 710, the content delivery manager 110 generates source sub-location video assignments 500ᵢ for source sub-location i 502 indicating video cameras at source sub-location i 504ᵢ determined corresponding target sub-location 506; and a target content delivery server 508 for the target sub-location 506. The target sub-location 114ᵢ and corresponding source sub-location 102ᵢ may have the same angles of points-of view for people located in the corresponding target 114ᵢ and source 102ᵢ sub-locations. In certain embodiments, the target content delivery server 508 may comprise a server closest to the most points within the target sub-location 506 over other target content delivery servers 400ⱼ. In certain embodiments, one target content delivery server 400ᵢ may be associated with multiple, but less than all, target sub-locations 114ᵢ.

In one embodiment, the content delivery manager 110 may configure the video cameras 504 to transmit their captured video sub-streams to the assigned target content delivery server 508, such as by updating target content delivery server (CDS) address 208 in the video cameras 504. In another embodiment, the video cameras 504 may transmit their captured video sub-streams to the main content delivery server 108 to reconstruct the video sub-streams from the video cameras 504 into a single volumetric video sub-stream to transmit to the indicated target content delivery server 508 to cache and transmit to viewers in the assigned target sub-location 506 corresponding to the source sub-location 604. The content delivery manager 110 may communicate (at block 714) with the determined target content delivery server 508 server to configure the target sub-location video assignment 600ᵢ in the target content delivery server 508, to indicate the assigned target sub-location 602 in field 506; the corresponding source sub-location 604 from field 502; the video cameras assigned to the source sub-location 606 from field 504; and target sub-location geographic coordinates 608 of the assigned target sub-location 602.

With the embodiment of operations of FIG. 7, the main content delivery server 108 may configure target content delivery servers 400ᵢ to receive video sub-streams from a designated source sub-location 102ᵢ to be dedicated to transmitting the video sub-stream from one source sub-location 102ᵢ to the assigned target sub location 114ᵢ. In this way, network 116 bandwidth is minimized because each target content delivery server 400ᵢ receives only a video sub-stream for one source sub-location 102ᵢ, which is a substantially smaller sized transmission than transmitting the combined video sub-streams for all source sub-locations 102ᵢ, thereby substantially conserving and minimizing network 116 bandwidth. Further, because target content delivery servers 400ᵢ are assigned to target sub-locations 114ᵢ geographically closest to the target sub-location 114ᵢ, wireless transmissions of the video sub-stream are transmitted at the fastest possible rate because a closest target content delivery server 400ᵢ in closest proximity to a target sub-location 114ᵢ is used to transmit the video sub-stream to the extended-reality headset 300ᵢ of viewers 104ᵢ to view at the target sub-location 114ᵢ.

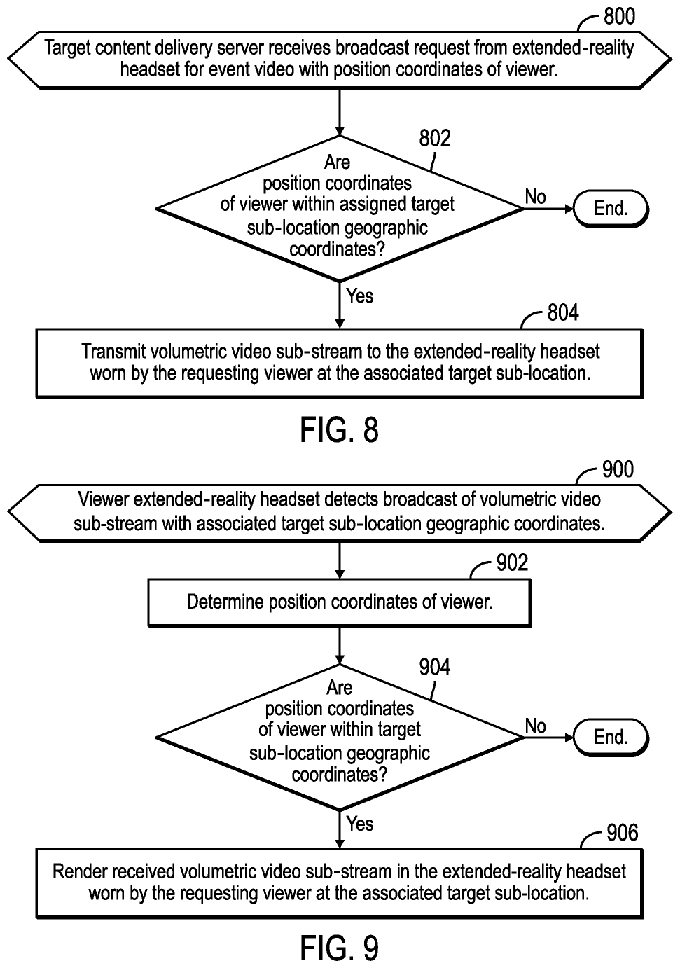

FIG. 8 illustrates an embodiment of operations performed by a target content delivery server 400ᵢ video server 408 to process a request from extended-reality headset 300ᵢ for a video sub-stream. Upon receiving (at block 800) by the video server 408 a request from extended-reality headset 300ᵢ for event video with the position coordinates of the viewer 104ᵢ, the video server 408 determines (at block 802) whether the position coordinates of the viewer 104ᵢ are within the target sub-location geographic coordinates 608 of the assigned target sub-location 602. If not, then control ends with the receiving target content delivery server 400ᵢ ignoring the request. In this way, the extended-reality headset 300ᵢ broadcasts the request to be processed by a target content delivery server 400ᵢ assigned to the target sub-location 114ᵢ in which the requesting viewer 104ᵢ is located. If (at block 802) the viewer 104ᵢ/extended-reality headset 300ᵢ are within the assigned target sub-location geographic coordinates 608, then the video server 408 transmits (at block 804) the volumetric video sub-stream to the extended-reality headset 300ᵢ worn by the requesting viewer 104ᵢ to view at the target location 106

In one embodiment, if the viewer 104ᵢ moves from one target sub-location 114ᵢ to another target sub-location 104ⱼ, then the extended-reality headset 300ᵢ on detecting such change may initiate a new request for a video sub-stream to obtain the video sub-stream from the closest target content delivery server 400ⱼ. Alternatively, the target content delivery server 400ᵢ may detect that the viewer 104ᵢ receiving the video sub-stream has moved to a new target sub-location 114ⱼ and then contact the closest target content delivery server 400ⱼ to handle the transmission or terminate transmission to cause the extended-reality headset 300ᵢ to issue a new request for a video-sub-stream from the closest target content delivery server 400ⱼ for the new target sub-location 104ⱼ.

With the embodiment of FIG. 8, a target content delivery server 400ᵢ only processes requests from viewers 104ᵢ in the target sub-location 114i assigned to that receiving target content delivery server 400ᵢ. Further, by having target content delivery servers 400ᵢ only cache and transmit video sub-streams for a specific source sub-location, network bandwidth in the network 116 and in the wireless network at the target location 106 is minimized to conserve network bandwidth and improve performance across all networks in which video sub-streams are transmitted. Further, transmission speeds are optimized to the extended-reality headset 300ᵢ by having the closest target content delivery servers 400ᵢ transmit to the viewers.

FIG. 9 illustrates an alternative embodiment where the target content delivery servers 400ᵢ broadcast their video sub-stream and the extended-reality headsets 300ᵢ throughout the target location 106 determine whether to render the broadcast video sub-stream from the transmitting target content delivery servers. The operations of FIG. 9 may be performed by the event viewer manager 304 in the computer 302 of the extended-reality headset 300ᵢ receiving the broadcast. Upon receiving (at block 900) a broadcast of a volumetric video sub-stream with associated target sub-location geographic coordinates 608, the position locator 306 determines (at block 902) position coordinates of the viewer 104ᵢ/extended-reality headset 300ᵢ. If (at block 904) the determined position coordinates of the viewer 104ᵢ are not within the target sub-location geographic coordinates 608 broadcasted with the content, then control ends with the extended-reality headset 300ᵢ ignoring the broadcast. If (at block 904) the viewer 104ᵢ is within the target sub-location geographic coordinates 608 assigned to the broadcasting target content delivery server 400ᵢ, then the event viewer manager 304 and extended-reality generator 308 render (at block 908) the received volumetric video sub-stream in the extended-reality headset 300ᵢ worn by the requesting viewer 104ᵢ to allow the viewer 104ᵢ to virtually interact and move within the environment rendered on the extended-reality headset 300ᵢ at the source location 100

With the embodiment of FIG. 9, the target content delivery servers 400ᵢ broadcast the video sub-streams, and extended-reality headset 300ᵢ throughout the target location 106 determine whether to render the virtual environment represented by the broadcast based on the location of the extended-reality headset 300ᵢ to allow targeting of location specific broadcasts to viewers in the target location 106. Further, by having target content delivery servers 400ᵢ only cache and transmit video sub-streams for a specific source sub-location, network bandwidth in the network 116 and in the wireless network at the target location 106 are minimized to conserve network bandwidth and improve performance across all networks in which video sub-streams are transmitted. Further, transmission speeds are optimized to the extended-reality headset 300ᵢ by having the closest target content delivery servers 400ᵢ transmit to extended-reality headset 300ᵢ.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

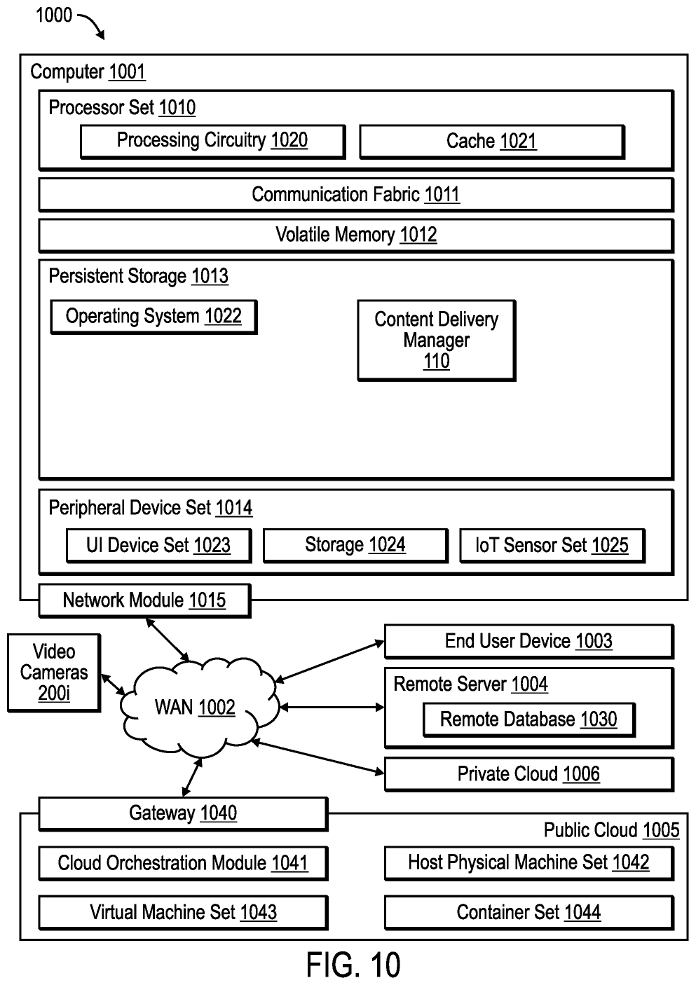

With respect to FIG. 10, computing environment 1000 contains an example of an environment for the execution of at least some of the computer code involved in performing the inventive methods of the main content delivery server 108, the target content delivery servers 400ᵢ, the video cameras 200ᵢ, and the extended-reality headset 300ᵢ. Computer 1001 may comprise the main content delivery server 108 having the content delivery manager 110. In addition, computing environment 1000 includes, for example, wide area network (WAN) 100₂, end user device (EUD) 1003, which may comprise the extended-reality headset 300ᵢ, remote server 1004, which may comprise the target content delivery servers 400i, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and content delivery manager 110, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044. Further, video cameras 200ᵢ stream video sub-streams captured from source sub-locations 102ᵢ at one or more source locations 100.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 110 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 110 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on. In described embodiments, the end user device 1003 may comprise the extended-reality headset 300ᵢ at one or more target locations 106.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004. In described embodiments, the remote server 1004 may comprise the target content delivery servers 1004 to cache video sub-streams to transmit to the extended-reality headset 300ᵢ.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The letter designators, such as i, j, and n among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for transmitting captured video streams to a viewer comprising a person wearing an extended-reality headset to view an event in an extended-reality environment, the computer program product comprising a computer readable storage medium having computer readable program code embodied therein that is executable to perform operations, the operations comprising:
assigning video cameras, positioned to capture video at a source location, to source sub-locations of the source location, wherein the video cameras assigned to a source sub-location capture video of the event from points-of-view of viewers within the source sub-location;
associating the source sub-locations of the source location with target sub-locations of a target location in which the viewer is located, wherein the source location and the target location are in different geographical locations; and
transmitting a video sub-stream from video cameras assigned to a source sub-location to be rendered in the extended-reality headset worn by a viewer located in a target sub-location associated with the source sub-location to which the video cameras that captured the video sub-stream are assigned.

2. The computer program product of claim 1, wherein the operations further comprise
receiving a request from the extended-reality headset worn by a viewer for a video sub-stream of the event; and
determining whether the extended-reality headset is within geographical coordinates of a target sub-location, wherein the video sub-stream is transmitted to the extended-reality headset in response to determining that the extended-reality headset sending the request is within the geographic coordinates of the target sub-location.

3. The computer program product of claim 1, wherein the transmitting the video sub-stream comprises broadcasting the video sub-stream with information on geographic coordinates of a target sub-location mapping to a source sub-location assigned the video cameras generating the video sub-stream, wherein the extended-reality headset worn by the viewer renders the broadcasted video sub-stream in response to determining that the extended-reality headset is located within the geographic coordinates of the target sub-location included in the broadcast.

4. The computer program product of claim 1, wherein the operations further comprise:
reconstructing video sub-streams from the video cameras assigned to the source sub-location to form a volumetric video sub-stream for the source sub-location, wherein the transmitted video sub-stream comprises the volumetric video sub-stream.

5. The computer program product of claim 1, wherein the video sub-stream transmitted to the extended-reality headset to render is captured by video cameras assigned to a source-sub location corresponding to the target sub-location in which the extended-reality headset is included.

6. The computer program product of claim 1, wherein the target sub-location comprises a first target sub-location, wherein the source sub-location comprises a second source sub-location, wherein the video sub-stream comprises a first video sub-stream, and wherein the video cameras capturing the first video sub-stream comprise first video cameras, wherein the operations further comprise:
transmitting a second video sub-stream from second video cameras assigned to the second source sub-location associated with a second target sub-location to be rendered in the extended-reality headset that rendered the first video sub-stream that is currently located in the second target sub-location.

7. The computer program product of claim 1, where the target location includes a plurality of viewers wearing extended-reality headsets viewing within the target sub-locations, wherein the transmitting the video sub-stream is performed for a plurality of video sub-streams, captured by video cameras associated with different source sub-locations, to be rendered in the extended-reality headsets of the viewers in the target sub-locations that are associated with the source sub-locations assigned the video cameras that captured the video sub-streams.

8. The computer program product of claim 1, wherein the operations further comprise:
assigning a plurality of target content delivery servers to the target sub-locations, where different of the target content delivery servers are assigned to different of the target sub-locations;
receiving, by a target content delivery server of the target content delivery servers, video sub-streams from the video cameras assigned to the source sub-location associated with the target sub-location assigned to the target content delivery server, wherein different of the target content delivery servers receive video sub-streams from different of the video cameras assigned to different of the source sub-locations; and
transmitting, by the target content delivery servers, video sub-streams from the source sub-locations to be rendered in extended-reality headsets worn by viewers located in target sub-locations associated with the source sub-locations to which the video cameras that captured the video sub-stream are assigned.

9. The computer program product of claim 8, wherein a target content delivery server assigned to a target sub-location is positioned closer to more areas of the assigned target sub-location than other of the target content delivery servers, and wherein viewers in a target sub-location render a video sub-stream from the target content delivery server assigned to the target sub-location.

10. The computer program product of claim 8, wherein the operations further comprise:
programming the video cameras assigned to a source sub-location to transmit their video sub-streams to a server assigned to the target sub-location associated with the source sub-location to which the video cameras are assigned, wherein the target content delivery servers receiving the video sub-streams from the video cameras assigned to a source sub-location reconstruct the received video sub-streams into a volumetric video sub-stream to transmit to viewers viewing from within the target sub-location assigned to a target content delivery server.

11. A system for transmitting captured video streams to a viewer comprising a person wearing an extended-reality headset to view an event in an extended-reality environment, comprising:
edge target content delivery servers,
a content delivery server including a computer readable storage medium having computer readable program code embodied therein that is executable by the content delivery server to perform operations, the operations comprising:
assigning video cameras, positioned to capture video at a source location, to source sub-locations of the source location, wherein the video cameras assigned to a source sub-location capture video of the event from points-of-view of viewers within the source sub-location;
associating the source sub-locations of the source location with target sub-locations of a target location in which the viewer is located, wherein the source location and the target location are in different geographical locations; and
transmitting a video sub-stream from video cameras assigned to a source sub-location to be rendered in the extended-reality headset worn by a viewer located in a target sub-location associated with the source sub-location to which the video cameras that captured the video sub-stream are assigned.

12. The system of claim 11, wherein the operations further comprise
receiving a request from the extended-reality headset worn by a viewer for a video sub-stream of the event; and
determining whether the extended-reality headset is within geographical coordinates of a target sub-location, wherein the video sub-stream is transmitted to the extended-reality headset in response to determining that the extended-reality headset sending the request is within the geographic coordinates of the target sub-location.

13. The system of claim 11, where the target location includes a plurality of viewers wearing extended-reality headsets viewing within the target sub-locations, wherein the transmitting the video sub-stream is performed for a plurality of video sub-streams, captured by video cameras associated with different source sub-locations, to be rendered in the extended-reality headsets of the viewers in the target sub-locations that are associated with the source sub-locations assigned the video cameras that captured the video sub-streams.

14. The system of claim 11, wherein the operations further comprise:
assigning a plurality of target content delivery servers to the target sub-locations, where different of the target content delivery servers are assigned to different of the target sub-locations;
wherein a target content delivery server of the target content delivery servers performs operations, the operations comprising:
receiving video sub-streams from the video cameras assigned to the source sub-location associated with the target sub-location assigned to the target content delivery server, wherein different of the target content delivery servers receive video sub-streams from different of the video cameras assigned to different of the source sub-locations; and
transmitting video sub-streams from the source sub-locations to be rendered in extended-reality headsets worn by viewers located in target sub-locations associated with the source sub-locations to which the video cameras that captured the video sub-stream are assigned.

15. The computer program product of claim 14, wherein a target content delivery server assigned to a target sub-location is positioned closer to more areas of the assigned target sub-location than other of the target content delivery servers, and wherein viewers in a target sub-location render a video sub-stream from the target content delivery server assigned to the target sub-location.

16. A method for transmitting captured video streams to a viewer comprising a person wearing an extended-reality headset to view an event in an extended-reality environment, comprising:
assigning video cameras, positioned to capture video at a source location, to source sub-locations of the source location, wherein the video cameras assigned to a source sub-location capture video of the event from points-of-view of viewers within the source sub-location;
associating the source sub-locations of the source location with target sub-locations of a target location in which the viewer is located, wherein the source location and the target location are in different geographical locations; and
transmitting a video sub-stream from video cameras assigned to a source sub-location to be rendered in the extended-reality headset worn by a viewer located in a target sub-location associated with the source sub-location to which the video cameras that captured the video sub-stream are assigned.

17. The method of claim 16, further comprising:
receiving a request from the extended-reality headset worn by a viewer for a video sub-stream of the event; and
determining whether the extended-reality headset is within geographical coordinates of a target sub-location, wherein the video sub-stream is transmitted to the extended-reality headset in response to determining that the extended-reality headset sending the request is within the geographic coordinates of the target sub-location.

18. The method of claim 16, where the target location includes a plurality of viewers wearing extended-reality headsets viewing within the target sub-locations, wherein the transmitting the video sub-stream is performed for a plurality of video sub-streams, captured by video cameras associated with different source sub-locations, to be rendered in the extended-reality headsets of the viewers in the target sub-locations that are associated with the source sub-locations assigned the video cameras that captured the video sub-streams.

19. The method of claim 16, further comprising:
assigning a plurality of target content delivery servers to the target sub-locations, where different of the target content delivery servers are assigned to different of the target sub-locations;
receiving, by a target content delivery server of the target content delivery servers, video sub-streams from the video cameras assigned to the source sub-location associated with the target sub-location assigned to the target content delivery server, wherein different of the target content delivery servers receive video sub-streams from different of the video cameras assigned to different of the source sub-locations; and
transmitting, by the target content delivery servers, video sub-streams from the source sub-locations to be rendered in extended-reality headsets worn by viewers located in target sub-locations associated with the source sub-locations to which the video cameras that captured the video sub-stream are assigned.

20. The method of claim 19, wherein a target content delivery server assigned to a target sub-location is positioned closer to more areas of the assigned target sub-location than other of the target content delivery servers, and wherein viewers in a target sub-location render a video sub-stream from the target content delivery server assigned to the target sub-location.
